(19) United States
(12) Patent Application Publication
(10) Pub. No.: US 2026/0184038 A1
(43) Pub. Date: Jul. 2, 2026

(54) DOWN-LIKE COMPOSITE STRUCTURE

(71) Applicant: SHINIH ENTERPRISE CO., LTD., TAOYUAN CITY (TW)

(72) Inventors: Jung-Fu CHIEN, Taoyuan City (TW); Chung-Shan PENG, Taoyuan City (TW); Kai-Chih CHUNG, Taoyuan City (TW); Ping-Yu CHIU, Taoyuan City (TW)

(73) Assignee: SHINIH ENTERPRISE CO., LTD., TAOYUAN CITY (TW)

(21) Appl. No.: 19/003,819

(22) Filed: Dec. 27, 2024

(51) Int. Cl. B32B 5/02; B32B 5/26

(52) U.S. Cl. CPC B32B 5/022; B32B 5/266; B32B 5/271; B32B 2262/124; B32B 2262/144; B32B 2262/16; B32B 2305/70; B32B 2307/72; B32B 2437/00

(57) ABSTRACT

The present invention provides a down-like composite structure, comprising a base layer and a down-like layer disposed on the base layer; wherein the base layer and down-like layer individually comprise a core-sheath fiber, a microfiber and a 3D curly fiber; the base layer is prepared by cross-stacking the above fibers and has a density of 14 gsm to 40 gsm; the down-like layer is prepared by randomly stacking the above fibers and has a density of 30 gsm to 400 gsm; the microfiber has a fineness of 0.1 D to 1.5 D; the 3D curly fiber has a hollowness of 5% to 30% and a crimp rate of 2% to 25%. The down-like composite structure of the present invention has a compression recovery rate of 90% or more. The present invention also provides articles and clothes prepared by the down-like composite structure.

### BACKGROUND OF THE INVENTION

### 1. Field of the Invention

The present invention relates to a down-like composite structure. In addition, the present invention also relates to an article and clothes prepared by the down-like composite structure, such as shoes, a comforter, a sleeping bag, a sleeping pad, a clothing accessory, and the like.

### 2. Description of the Prior Arts

Currently, there are many products made of padded fabric on the market, such as clothes, comforters, etc. in response to the demand for warmth. For traditional padded fabrics, the surface fabric and lining fabric are cut into pieces according to the pattern, then the pieces are sewed into multiple grids for filling according to the predetermined pattern, the grids are filled with down or other fiber materials, and the pieces filled with down or fibers are assembled into the final products. No matter using down or fibers, the grids are necessary for fixing the positions of down or fibers; and the filling process is quite cumbersome because the grids must be filled one by one.

The down or fibers filled in the traditional padded fabric will contact the moisture in the external environment or from the user's body; and, the down or fibers will directly contact water because the padded fabrics are usually cleaned by washing. No matter contacting the moisture in the air or the moisture from the user's body, or directly washing with water, the down or fibers in grids may stick to each other due to moisture or water, and are easily displaced or deformed, thereby deteriorating the feel, appearance and warmth of the padded fabric. In addition, the cut pieces of the traditional padded fabric need to be sewed, and pin holes are formed on the fabrics. So the down or fibers filled inside may move outward from the gaps between the cloth fibers and these pin holes (known as fiber-migration), and the amount of down or fibers filled in the grids may be reduced after long-term use.

To overcome the shortcomings of the traditional padded fabric, down-like fiber products have been developed and introduced into the market. Although these fiber products are soft and have good compression recovery rate, they still need to be filled into grids, leading to limitations in clothes design. And, these fibers tangle easily after washing. Padded fabric formed by stacking multiple layers of non-woven fabrics composed of thermal insulating fibers is introduced into the market, and this padded fabric is a sheet material, easy for cut and clothes design, while not easy to tangle so as to have good launderability. However, the fibers in this padded fabric is combed into webs and cross-stacked into layers, and resin is needed for fixing fiber interlocking points on the surface in order to prevent fiber-migration. So the padded fabric has poor compression recovery rate.

Therefore, it still needs to provide a thermal insulating sheet material which is soft, has no need to fill, and has a good launderability and good compression recovery rate.

### SUMMARY OF THE INVENTION

To overcome the shortcomings, one objective of the present invention is to provide a down-like composite structure, which is a sheet material (and can be prepared as a roll material), for which no fiber filling process is needed for preparation, and the down-like composite structure of the present invention has a good CLO value, good launderability, and low fiber-migration. In addition, resin for fixing fiber interlocking points on the surface in order to prevent fiber-migration is not needed for the down-like composite structure of the present invention, and the down-like composite structure of the present invention has good compression recovery rate.

Another objective of the present invention is to provide an article and clothes prepared by the down-like composite structure of the present invention, such as shoes, a comforter, a sleeping bag, a sleeping pad, a clothing accessory, and the like.

To achieve the objectives, the present invention provides a down-like composite structure, comprising:
a base layer, based on the total weight of the down-like composite structure, the base layer having a weight of 9 percent by weight (wt %) to 27 wt %; the base layer comprising 30 wt % to 60 wt % of a first core-sheath fiber, 10 wt % to 50 wt % of a first microfiber and 20 wt % to 30 wt % of a first three-dimensional (3D) curly fiber; the first core-sheath fiber, the first microfiber and the first 3D curly fiber mixed and cross-stacked to obtain the base layer, and the base layer having a density of 14 gsm (grams per square meter, or g/m²) to gsm; and
a down-like layer disposed on the base layer, based on the total weight of the down-like composite structure, the down-like layer having a weight of 73 wt % to 91 wt %; the down-like layer comprising 10 wt % to 30 wt % of a second core-sheath fiber, 30 wt % to 70 wt % of a second microfiber and 20 wt % to 40 wt % of a second 3D curly fiber, the second core-sheath fiber, the second microfiber and the second 3D curly fiber mixed and randomly stacked to obtain the down-like layer, and the down-like layer having a density of 30 gsm to 400 gsm;
wherein, the first core-sheath fiber and the second core-sheath fiber individually comprise a core part and a sheath part, and the sheath part covers part of or all of the outer surface of the core part; the core part is made of a virgin or recycled first polymer material, the sheath part is made of a virgin or recycled second polymer material, the melting point of the second polymer material is lower than the melting point of the first polymer material, and the melting point of the second polymer material ranges from 100° C. to 200° C.;
the first microfiber and the second microfiber individually have a fineness of 0.1 D TO 1.5 D;
the first 3D curly fiber and the second 3D curly fiber individually have a hollowness of 5% to 30%; and
the first 3D curly fiber and the second 3D curly fiber individually have a crimp rate of 2% to 25%.

In some embodiments, based on the total weight of the down-like composite structure, the base layer has a weight of 9 wt %, and the down-like layer has a weight of 91 wt %. In some embodiments, based on the total weight of the down-like composite structure, the base layer has a weight of 10 wt %, and the down-like layer has a weight of 90 wt %. In some embodiments, based on the total weight of the down-like composite structure, the base layer has a weight of 13 wt %, and the down-like layer has a weight of 87 wt %. In some embodiments, based on the total weight of the down-like composite structure, the base layer has a weight of 15 wt %, and the down-like layer has a weight of 85 wt %. In some embodiments, based on the total weight of the down-like composite structure, the base layer has a weight of 20 wt %, and the down-like layer has a weight of 80 wt %. In some embodiments, based on the total weight of the down-like composite structure, the base layer has a weight of 25 wt %, and the down-like layer has a weight of 75 wt %. In some embodiments, based on the total weight of the down-like composite structure, the base layer has a weight of 26 wt %, and the down-like layer has a weight of 74 wt %. In some embodiments, based on the total weight of the down-like composite structure, the base layer has a weight of 27 wt %, and the down-like layer has a weight of 73 wt %.

In some embodiments, the base layer has a thickness of about 0.2 centimeters (cm) to 0.3 cm, or about 0.25 cm to 0.3 cm. In some embodiments, the down-like layer has a thickness of about 2.0 cm to 6.0 cm, or about 3.0 cm to 5.0 cm, or about 4.0 cm to 5.0 cm.

In some embodiments, the ratio of the base layer thickness to the down-like layer thickness is 1:6 to 1:30. In some embodiments, the ratio of the base layer thickness to the down-like layer thickness is 1:10 to 1:25, or 1:15 to 1:20.

In some embodiments, the base layer has a density of 14 gsm to 40 gsm, or 15 gsm to 35 gsm, or 20 gsm to 30 gsm, or 20 gsm to 25 gsm.

In some embodiments, the down-like layer comprises the second core-sheath fiber, the second microfiber, the second 3D curly fiber and air. In the present invention, the above three fibers are not intensively stacked together, and a certain amount of air is comprised in between, in order to increase thermal insulating effect. In some embodiments, the down-like layer has a density of 30 gsm to 400 gsm, or 50 gsm to 350 gsm, or 100 gsm to 300 gsm, or 150 gsm to 200 gsm.

In some embodiments, the base layer comprises 30 wt % to 60 wt % of the first core-sheath fiber, 20 wt % to 40 wt % of the first microfiber and 20 wt % to 30 wt % of the first 3D curly fiber.

In some embodiments, the down-like layer comprises 10 wt % to 30 wt % of the second core-sheath fiber, 40 wt % to 60 wt % of the second microfiber and 20 wt % to 40 wt % of the second 3D curly fiber.

In some embodiments, based on the total weight of the first core-sheath fiber, the core part is in an amount of 40 wt % to 80 wt %, and the sheath part is in an amount of 60 wt % to 20 wt %. In some embodiments, based on the total weight of the first core-sheath fiber, the core part is in an amount of 40 wt % to 70 wt %, and the sheath part is in an amount of 60 wt % to 30 wt %. In some embodiments, based on the total weight of the first core-sheath fiber, the core part is in an amount of 40 wt % to 60 wt %, and the sheath part is in an amount of 60 wt % to 40 wt %. In some embodiments, based on the total weight of the first core-sheath fiber, the core part is in an amount of 45 wt % to 55 wt %, and the sheath part is in an amount of 55 wt % to 45 wt %. In some embodiments, based on the total weight of the first core-sheath fiber, the core part is in an amount of 48 wt % to 52 wt %, and the sheath part is in an amount of 52 wt % to 48 wt %. In some embodiments, based on the total weight of the first core-sheath fiber, the core part is in an amount of 50 wt %, and the sheath part is in an amount of 50 wt %.

In some embodiments, based on the total weight of the second core-sheath fiber, the core part is in an amount of 40 wt % to 80 wt %, and the sheath part is in an amount of 60 wt % to 20 wt %. In some embodiments, based on the total weight of the second core-sheath fiber, the core part is in an amount of 40 wt % to 70 wt %, and the sheath part is in an amount of 60 wt % to 30 wt %. In some embodiments, based on the total weight of the second core-sheath fiber, the core part is in an amount of 40 wt % to 60 wt %, and the sheath part is in an amount of 60 wt % to 40 wt %. In some embodiments, based on the total weight of the second core-sheath fiber, the core part is in an amount of 45 wt % to 55 wt %, and the sheath part is in an amount of 55 wt % to 45 wt %. In some embodiments, based on the total weight of the second core-sheath fiber, the core part is in an amount of 48 wt % to 52 wt %, and the sheath part is in an amount of 52 wt % to 48 wt %. In some embodiments, based on the total weight of the second core-sheath fiber, the core part is in an amount of 50 wt %, and the sheath part is in an amount of 50 wt %.

In some embodiments, the first polymer material and the second polymer material are individually selected from a group consisting of polyethylene (PE), polypropylene (PP), polyethylene terephthalate (PET), polyethylene terephthalate copolymer (PET copolymer, coPET) or other polymer analogues. In some embodiments, the combination of the first polymer material and the second polymer material is represented as first polymer material/second polymer material (i.e., core part/sheath part), and the combination is selected from a group consisting of polyethylene terephthalate/polyethylene (PET/PE), polyethylene terephthalate/polyethylene terephthalate copolymer (PET/coPET), and polypropylene/polyethylene (PP/PE). In some embodiments, polyethylene terephthalate copolymer is a co-polyester of PET and a dicarboxylic acid, and the dicarboxylic acid may be selected from aliphatic dicarboxylic acids and aromatic dicarboxylic acids; wherein the aliphatic dicarboxylic acids may be oxalic acid, malonic acid, succinic acid, adipic acid and the like; the aromatic dicarboxylic acids may be isophthalic acid, sulfoisophthalic acid and the like.

In some embodiments, the melting point of the second polymer material is lower than the melting point of the first polymer material, and the melting point of the second polymer material ranges from 100° C. to 200° C., or 120° C. to 180° C., or 140° C. to 160° C., or 140° C. to 150° C.

In the present invention, the term “virgin” indicates that the material is a raw material, which is not previously used to produce any products. In the present invention, the term “recycled” indicates that the material is leftover bits and pieces of the industrially-produced products or a recycled material, not a raw material. Taking the most common recycled polyester material for example, the regenerated polyester materials which can be produced into fibers have two main resources: one is pre-consumer and post-consumer polyester fabrics, and the other is the post-consumer PET bottles; these polyester materials are recycled and reproduced into an environmentally friendly regenerated fiber material by physical or chemical methods. In the present invention, the terms “recycled” and “regenerated” can be used exchangeably.

In some embodiments, the down-like composite structure of the present invention comprises a regenerated component in an amount of 20% or more (≥20%), which meets the standard of GRS certification. In some embodiments, the down-like composite structure of the present invention comprises a regenerated component in an amount of 30% or more (≥30%), or 35% or more (≥35%).

In some embodiments, the first core-sheath fiber has a fineness of 1.5 Deniers (D) to 15 D, or 1.5 D to 10 D, or 2 D to 5 D, or 2 D to 4 D, or 2 D to 3 D. In some embodiments, the second core-sheath fiber has a fineness of 1.5 D to 15 D, or 1.5 D to 10 D, or 2 D to 5 D, or 2 D to 4 D, or 2 D to 3 D.

In some embodiments, the first core-sheath fiber has a cross section, the cross section is circular or trilobal shaped; when the cross section is circular, the core part of the cross section is located centrally or non-centrally in the circular cross section, and the sheath part covers all of the outer surface of the core part; when the cross section is trilobal shaped, the sheath part covers part of the outer surface of the core part. In some embodiments, the cross section of the first core-sheath fiber is trilobal shaped, and the sheath parts are located at the end parts of each lobe of the trilobal cross section.

In some embodiments, the second core-sheath fiber has a cross section, the cross section is circular or trilobal shaped; when the cross section is circular, the core part is located centrally or non-centrally in the circular cross section, and the sheath part covers all of the outer surface of the core part; when the cross section is trilobal shaped, the sheath part covers part of the outer surface of the core part. In some embodiments, the cross section of the second core-sheath fiber is trilobal shaped, and the sheath parts are located at the end parts of each lobe of the trilobal cross section.

In some embodiments, the first core-sheath fiber is a two-dimensional (2D) jagged fiber. In some embodiments, the second core-sheath fiber is a 2D jagged fiber.

In some embodiments, the first core-sheath fiber and second core-sheath fiber are the same fiber. In some embodiments, the first core-sheath fiber and second core-sheath fiber are different fibers.

In some embodiments, the first microfiber is made of a virgin or recycled third polymer material, and the third polymer material is selected from a group consisting of polyethylene (PE), polypropylene (PP), polyethylene terephthalate (PET), polytrimethylene terephthalate (PTT), polybutylene terephthalate (PBT), polyamide (PA, also named Nylon) and a combination thereof. In some embodiments, the second microfiber is made of a virgin or recycled third polymer material, and the third polymer material is selected from a group consisting of polyethylene (PE), polypropylene (PP), polyethylene terephthalate (PET), polytrimethylene terephthalate (PTT), polybutylene terephthalate (PBT), polyamide (PA) and a combination thereof.

In some embodiments, the first microfiber has a fineness of 0.1 D to 1.5 D, or 0.5 D to 1.5 D, or 0.7 D to 1.5 D, or 0.9 D to 1.5 D, or 0.9 D to 1.4 D, or 1.0 D to 1.4 D. In some embodiments, the second microfiber has a fineness of 0.1 D to 1.5 D, or 0.5 D to 1.5 D, or 0.7 D to 1.5 D, or 0.9 D to 1.5 D, or 0.9 D to 1.4 D, or 1.0 D to 1.4 D.

In some embodiments, the first microfiber is a solid fiber or a hollow fiber. In some embodiments, the second microfiber is a solid fiber or a hollow fiber.

In some embodiments, the first microfiber is a hollow fiber having a hollowness of 3% to 25%, or 5% to 20%, or 10% to 20%. In some embodiments, the second microfiber is a hollow fiber having a hollowness of 3% to 25%, or 5% to 20%, or 10% to 20%.

In some embodiments, the first microfiber is a 2D jagged fiber. In some embodiments, the second microfiber is a 2D jagged fiber.

In some embodiments, the 3D curly fiber is a bicomponent fiber.

In some embodiments, the first 3D curly fiber is a side-by-side bicomponent fiber, and the side-by-side bicomponent fiber comprises a first side part and a second side part disposed parallelly to each other; the first side part is made of a virgin or recycled fourth polymer material, the second side part is made of a virgin or recycled fifth polymer material, and the fourth polymer material and fifth polymer material are individually selected from a group consisting of polyethylene (PE), polypropylene (PP), polyethylene terephthalate (PET), polyethylene terephthalate copolymer (coPET), polybutylene terephthalate (PBT), polyamide (PA) and other polymer analogues.

In some embodiments, the second 3D curly fiber is a side-by-side bicomponent fiber, and the side-by-side bicomponent fiber comprise a first side part and a second side part disposed parallelly to each other, the first side part is made of a virgin or recycled fourth polymer material, the second side part is made of a virgin or recycled fifth polymer material, the fourth polymer material and fifth polymer material are individually selected from a group consisting of polyethylene (PE), polypropylene (PP), polyethylene terephthalate (PET), polyethylene terephthalate copolymer (coPET), polybutylene terephthalate (PBT), polyamide (PA) and other polymer analogues.

In some embodiments, the fourth polymer material and fifth polymer material are individually selected from a group consisting of polyethylene (PE), polypropylene, polyethylene terephthalate, polyethylene terephthalate copolymer (PET copolymer, coPET) or other polymer analogues. In some embodiments, the combination of the fourth polymer material and fifth polymer material is represented as fourth polymer material/fifth polymer material (i.e., first side part/second side part), and the combination is selected from a group consisting of polyethylene/polyethylene terephthalate (PE/PET), polyethylene terephthalate/polyethylene terephthalate copolymer (PET/coPET), polyethylene/polypropylene (PE/PP), and polyethylene terephthalate/polyethylene terephthalate (PET/PET). In some embodiments, polyethylene terephthalate copolymer is a co-polyester of PET and a dicarboxylic acid, and the dicarboxylic acid may be selected from aliphatic dicarboxylic acids and aromatic dicarboxylic acids; wherein the aliphatic dicarboxylic acids may be oxalic acid, malonic acid, succinic acid, adipic acid and the like; the aromatic dicarboxylic acids may be isophthalic acid, sulfoisophthalic acid and the like.

In some embodiments, the combination of the fourth polymer material and the fifth polymer material is represented as fourth polymer material/fifth polymer material, and the combination is first polyethylene terephthalate/second polyethylene terephthalate (PET/PET), wherein the first polyethylene terephthalate and the second polyethylene terephthalate have different inherent viscosity (IV). When the first polyethylene terephthalate and the second polyethylene terephthalate have an inherent viscosity difference (ΔIV) of 0.15 dL/g or more, a good 3D curl rate can be obtained; preferably, ΔIV is 0.25 dL/g or more. When ΔIV is lower than 0.15 dL/g, the curl rate is too low to have a sufficient 3D curl rate.

In some embodiments, the first 3D curly fiber is a solid fiber or a hollow fiber. In some embodiments, the first 3D curly fiber is a solid fiber having a cross section, the cross section is circular or peanut shaped; when the cross section is circular, the first side part and the second side part of the cross section are semicircular in shape and oppositely disposed; when the cross section is peanut shaped, the first side part and the second side part of the cross section connect in the middle of the cross section and individually protrude to both ends. In some embodiments, the first 3D curly fiber is a hollow fiber having a cross section, the cross section is circular, and the cross section has a hollow part; when the hollow part is located centrally in the circular cross section, the first side part and second side part are C-shaped in roughly the same shape; when the hollow part is located non-centrally in the circular cross section, the first side part and the second side part are C-shaped in different shapes.

In some embodiments, the second 3D curly fiber is a solid fiber or a hollow fiber. In some embodiments, the second 3D curly fiber is a solid fiber having a cross section, and the cross section is circular or peanut shaped; when the cross section is circular, the first side part and the second side part of the cross section are semicircular in shape and oppositely disposed; when the cross section is peanut shaped, the first side part and the second side part of the cross section connect in the middle of the cross section and individually protrude to both ends. In some embodiments, the second 3D curly fiber is a hollow fiber having a cross section, the cross section is circular, and the cross section has a hollow part; when the hollow part is located centrally in the circular cross section, the first side part and the second side part are C-shaped in roughly the same shape; when the hollow part is located non-centrally in the circular cross section, the first side part and the second side part are C-shaped in different shapes.

In some embodiments, the hollow part of the cross section has a diameter smaller than the circular cross section. In some embodiments, the hollow part is circular.

In some embodiments, the first 3D curly fiber has a fineness of 1 D to 15 D, or 5 D to 12 D, or 7 D to 10 D. In some embodiments, the second 3D curly fiber has a fineness of 1 D to 15 D, or 5 D to 12 D, or 7 D to 10 D.

In some embodiments, the first 3D curly fiber has a hollowness of 5% to 30%, or 10% to 25%, or 15% to 20%; In some embodiments, the second 3D curly fiber has a hollowness of 5% to 30%, or 10% to 25%, or 15% to 20%.

In some embodiments, the first 3D curly fiber has a crimp rate of 2% to 25%, or 5% to 20%, or 7% to 15%, or 7% to 10%. In some embodiments, the second 3D curly fiber has a crimp rate of 2% to 25%, or 5% to 20%, or 7% to 15%, or 7% to 10%.

In the present invention, the first core-sheath fiber (having a sheath part formed by the second polymer material with a lower melting point), the first microfiber and the first 3D curly fiber are mixed and cross-stacked to form a base layer, as a base layer roll material; then the base layer roll material is transported passing directly under a down-dropping machine by a first conveyor, meanwhile the second core-sheath fiber (having a sheath part formed by the second polymer material with a lower melting point), the second microfiber and the second 3D curly fiber are mixed and randomly stacked to form a down-like pre-prepared layer, and the down-like pre-prepared layer is superimposed on the base layer; after that, the base layer superimposed with the down-like pre-prepared layer is sent to a heating device and heated at a temperature at 125° C. or more, to melt the sheath parts of the first and second core-sheath fibers (formed by the second polymer material with a lower melting point) in the base layer and the down-like pre-prepared layer, and bind the first and second core-sheath fibers with adjacent fibers; after setting and cooling to room temperature, the down-like pre-prepared layer is formed into the down-like layer, thereby obtaining the down-like composite structure of the present invention, which can be rolled directly to give a down-like composite structure roll material. The first and second core-sheath fibers can reinforce the cross-linked structure of the first and second core-sheath fibers and other fibers (the first and second microfibers, and the first and second 3D curly fibers), to maintain the structures of the base layer and the down-like layer. The first and second core-sheath fibers are part of the materials of the base layer and the down-like layer, respectively; after the sheath parts melt, the core parts can still support, so the above melting and binding steps will not excessively influence the expansion of the base layer and the down-like layer.

In some embodiments, the first core-sheath fiber, the first microfiber and the first 3D curly fiber are evenly mixed.

In some embodiments, the second core-sheath fiber, the second microfiber and the second 3D curly fiber are evenly mixed.

In some embodiments, the second core-sheath fiber, the second microfiber and the second 3D curly fiber are mixed and randomly stacked, and absorbed by a negative pressure from a negative pressure device, to form the down-like pre-prepared layer.

In some embodiments, the down-like composite structure of the present invention can maintain a fixed shape without any additional fixing layer (such as a fixing layer formed by spraying a resin on the down-like layer).

In some embodiments, the first core-sheath fiber of the base layer can bind the adjacent first and second core-sheath fibers, the adjacent first and second microfibers and the adjacent first and second 3D curly fibers to form multiple binding points via the sheath part of the first core-sheath fiber. In some embodiments, the second core-sheath fiber of the down-like layer can bind the adjacent first and second core-sheath fibers, the adjacent first and second microfibers and the adjacent first and second 3D curly fibers to form multiple binding points via the sheath part of the second core-sheath fiber.

In some embodiments, the down-like composite structure of the present invention has a compression recovery rate of higher than 90%, or higher than 91%, or higher than 92%, or higher than 93%, or higher than 94%, or higher than 95%.

In some embodiments, the clothes prepared by the down-like composite structure of the present invention may be a shirt, a blouse, trousers, a skirt, a vest, or a coat, but is not limited thereto.

In some embodiments, the article prepared by the down-like composite structure of the present invention may be shoes, a comforter, a sleeping bag, a sleeping pad or a clothing accessory, but is not limited thereto.

### BRIEF DESCRIPTION OF THE DRAWINGS

FIG. 1 is the three-dimensional schematic diagram of the down-like composite structure of the present invention.

FIG. 2A is the schematic diagram of the core-sheath fiber of the present invention.

FIG. 2B is the schematic diagram of the microfiber of the present invention.

FIG. 2C is the schematic diagram of the 3D curly fiber of the present invention.

FIGS. 3A to 3C are the cross section schematic diagrams of the core-sheath fiber of the present invention.

FIGS. 3D to 3G are the cross section schematic diagrams of the 3D curly fiber of the present invention.

FIG. 4 is the schematic diagram of the preparation process of the down-like composite structure of the present invention.

FIG. 5A is the photograph of the multi-layer structure of the commercially available padded fabric.

FIG. 5B is the photograph of the down-like composite structure of the present invention.

### DETAILED DESCRIPTION OF THE PREFERRED EMBODIMENTS

Other objectives, advantages and novel features of the invention will become more apparent from the following detailed description when taken in conjunction with the accompanying drawings.

### Preparation of the Down-Like Composite Structure of the Present Invention

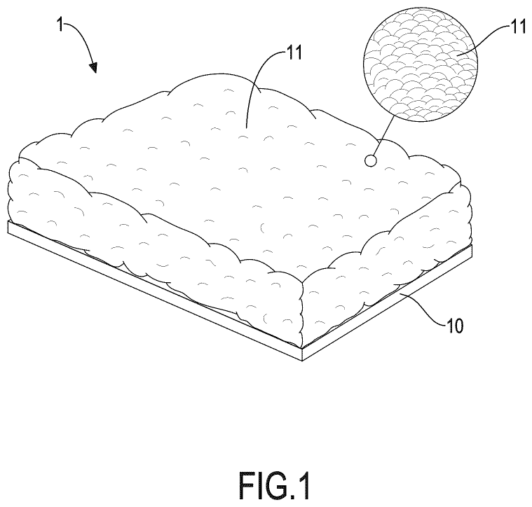

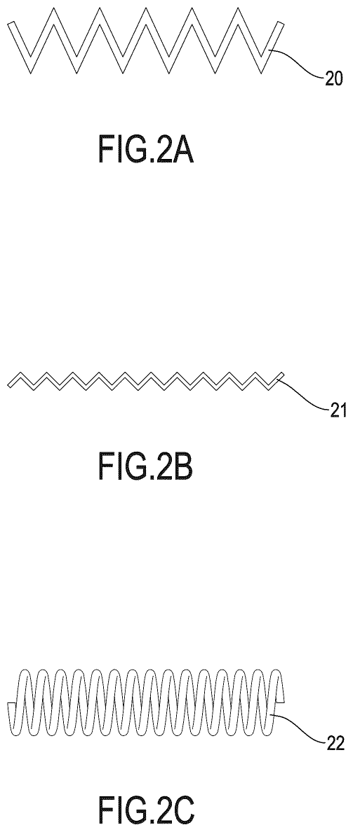

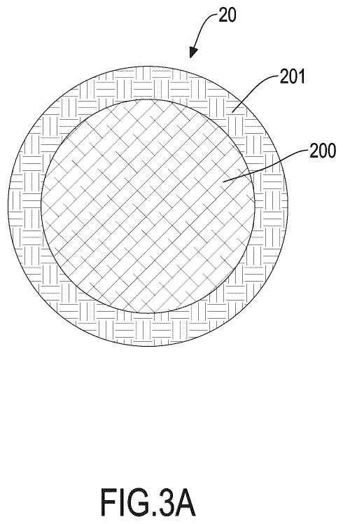

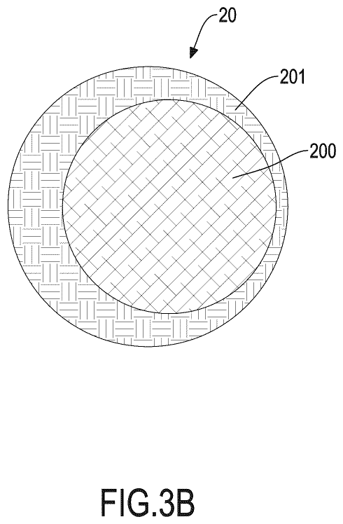

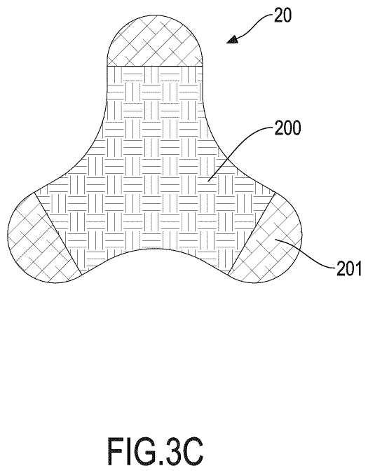

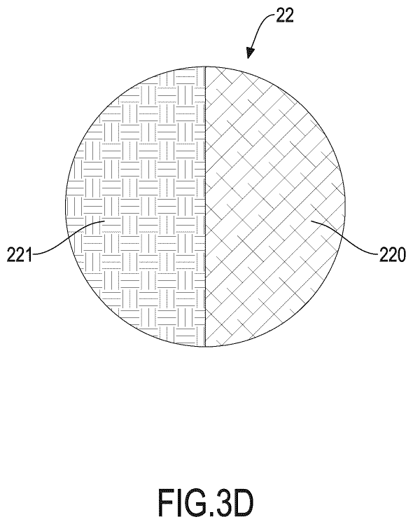

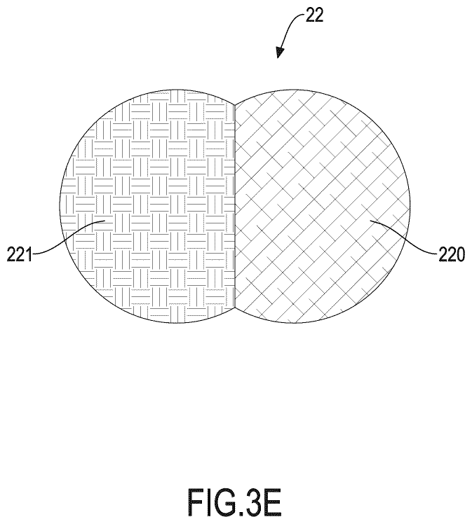

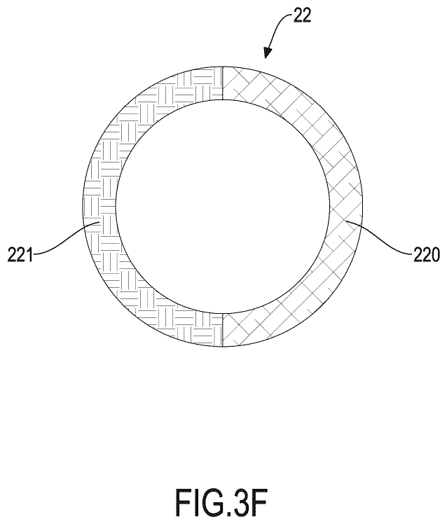

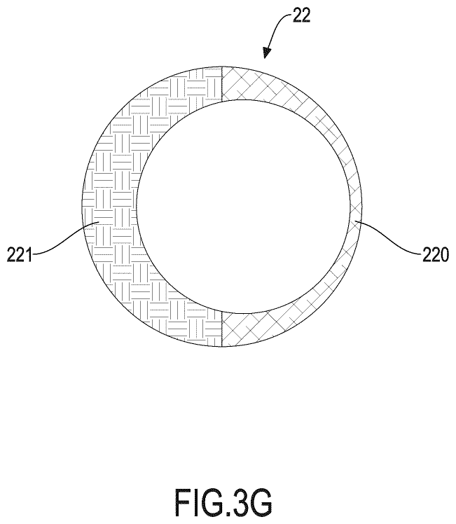

As shown in FIG. 1 and FIGS. 2A to 2C, the down-like composite structure of the present invention 1 comprises a base layer 10 and a down-like layer 11, wherein the down-like layer 11 is disposed on the base layer 10. Based on the total weight of the down-like composite structure 1, the base layer 10 has a weight of 9 wt % to 27 wt %; the base layer 10 comprises 30 wt % to 60 wt % of a first core-sheath fiber 20, 10 wt % to 50 wt % of a first microfiber 21 and 20 wt % to 30 wt % of a first 3D curly fiber 22; the first core-sheath fiber 20, the first microfiber 21 and the first 3D curly fiber 22 are mixed and cross-stacked to obtain the base layer 10 (not shown in figures); and the base layer 10 has a density of 14 gsm to 40 gsm. In addition, based on the total weight of the down-like composite structure 1, the down-like layer 11 has a weight of 73 wt % to 91 wt %; the down-like layer 11 comprises 10 wt % to 30 wt % of a second core-sheath fiber 20, 30 wt % to 70 wt % of a second microfiber 21 and 20 wt % to 40 wt % of a second 3D curly fiber 22; the second core-sheath fiber 20, the second microfiber 21 and the second 3D curly fiber 22 are mixed and randomly stacked to obtain the down-like layer 11; and the down-like layer 11 has a density of 30 gsm to 400 gsm. In FIG. 1, the down-like layer 11 is locally magnified, and it can be observed that the stacked fibers are puffy cloud-like shaped. The first and second core-sheath fibers 20 (as shown in FIG. 2A) and the first and second microfibers 21 (as shown in FIG. 2B) are 2D jagged fibers, and the first and second 3D curly fibers 22 (as shown in FIG. 2C) are 3D curly fibers. The second core-sheath fiber 20, the second microfiber 21 and the second 3D curly fiber 22 of the down-like layer 11 are not intensively stacked together, and a certain amount of air is comprised in between (not shown in figures).

Wherein, the first core-sheath fiber 20 and the second core-sheath fiber 20 individually comprise a core part 200 and a sheath part 201, and the sheath part 201 covers part of or all of the outer surface of the core part 200; the core part 200 is made of a virgin or recycled first polymer material, the sheath part 201 is made of a virgin or recycled second polymer material, and the melting point of the second polymer material is lower than the melting point of the first polymer material, and the melting point of the second polymer material ranges from 100° C. to 200° C. The first polymer material and the second polymer material are individually selected from a group consisting of polyethylene, polypropylene, polyethylene terephthalate, polyethylene terephthalate copolymer and other polymer analogues.

Wherein, based on the total weight of the first core-sheath fiber 20, the core part 200 is in an amount of 50 wt %, and the sheath part 201 is in an amount of 50 wt %; and based on the total weight of the second core-sheath fiber 20, the core part 200 is in an amount of 50 wt %, and the sheath part 201 is in an amount of 50 wt %. The cross sections of the first core-sheath fiber 20 and second core-sheath fiber 20 may individually comprise one or more configurations, for example, the first core-sheath fiber 20 and the second core-sheath fiber 20 may individually have a cross section, and the cross section is circular or trilobal shaped; when the cross section is circular, the core part 200 is located centrally (as shown in FIG. 3A) or non-centrally (as shown in FIG. 3B) in the circular cross section, and the sheath part 201 covers all of the outer surface of the core part 200; when the cross section is trilobal shaped, the sheath part 201 covers part of the outer surface of the core part 200, and the sheath parts 201 are located at the end parts of each lobe of the trilobal cross section (as shown in FIG. 3C).

Wherein, the first microfiber 21 and the second microfiber 21 are individually made of a virgin or recycled third polymer material selected from a group consisting of polyethylene, polypropylene, polyethylene terephthalate, polytrimethylene terephthalate, polybutylene terephthalate, polyamide and a combination thereof.

Wherein, the first microfiber 21 and the second microfiber 21 individually have a fineness of 0.1 D to 1.5 D.

Wherein, the first 3D curly fiber 22 and the second 3D curly fiber 22 are individually a side-by-side bicomponent fiber, and the side-by-side bicomponent fiber comprises a first side part 220 and a second side part 221 disposed parallelly to each other, the first side part 220 is made of a virgin or recycled fourth polymer material, the second side part 221 is made of a virgin or recycled fifth polymer material, and the fourth polymer material and the fifth polymer material are individually selected from polyethylene, polypropylene, polyethylene terephthalate, polyethylene terephthalate copolymer, polybutylene terephthalate, polyamide and other polymer analogues.

Wherein, the cross section of the first 3D curly fiber 22 and the second 3D curly fiber 22 may individually comprise one or more configurations, for example, the first and second 3D curly fibers 22 may each be a solid fiber having a cross section, and the cross section is circular or peanut shaped; when the cross section is circular, the first side part 220 and the second side part 221 of the cross section are semicircular in shape and oppositely disposed (as shown in FIG. 3D); when the cross section is peanut shaped, the first side part 220 and the second side part 221 of the cross section connect in the middle of the cross section and individually protrude to both ends (as shown in FIG. 3E); or, the first and second 3D curly fibers 22 may each be a hollow fiber having a cross section, the cross section is circular, and the cross section has a hollow part; when the hollow part is located centrally in the circular cross section, the first side part 220 and second side part 221 are C-shaped in roughly the same shape (as shown in FIG. 3F); when the hollow part is located non-centrally in the circular cross section, the first side part 220 and the second side part 221 are C-shaped in different shapes (as shown in FIG. 3G).

Wherein, the first and second 3D curly fibers 22 individually have a hollowness of 5% to 30%.

Wherein, the first and second 3D curly fibers 22 individually have a crimp rate of 2% to 25%.

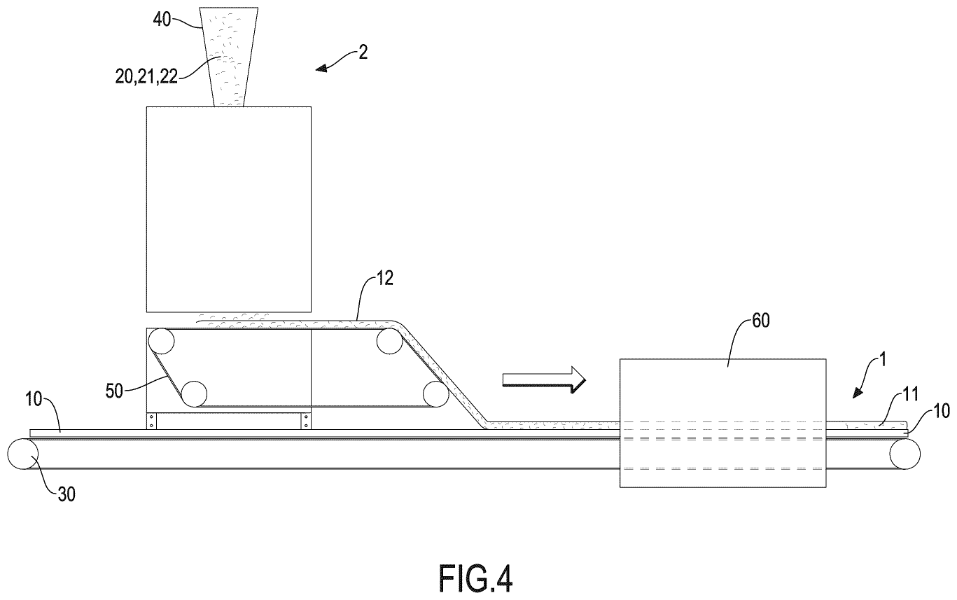

The preparation process of the down-like composite structure of the present invention 1 is shown in FIG. 4. First of all, the first core-sheath fiber 20, the first microfiber 21 and the first 3D curly fiber 22 were mixed and cross-stacked to form a base layer 10, as a roll material; then the roll material of the base layer 10 was transported passing directly under a down-dropping machine by a first conveyor 30. The down-dropping machine 2 had a feeding hopper 40, a second conveyor 50, and a heating device 60. The second core-sheath fiber 20, the second microfiber 21 and the second 3D curly fiber 22 were introduced from the feeding hopper 40 into the down-dropping machine 2, and the second core-sheath fiber 20, the second microfiber 21 and the second 3D curly fiber 22 were mixed and fallen randomly to stack and form a down-like pre-prepared layer 12, and the down-like pre-prepared layer 12 was transported by the second conveyor 50 to superimpose on the base layer 10 transported by the first conveyor 30; after that, the base layer 10 superimposed with the down-like pre-prepared layer 12 was sent to a heating device 60. The heating device could heat at a temperature of 125° C. or more, to melt the sheath parts 201 (formed by a polymer material with a lower melting point) of the first core-sheath fiber 20 in the base layer 10 and the second core-sheath fiber 20 in the down-like layer 11 and bind adjacent fibers; after setting and cooling to room temperature, the down-like pre-prepared layer 12 was formed into the down-like layer 11, thereby obtaining the down-like composite structure of the present invention 1 which could be rolled directly to give a roll material of the down-like composite structure 1. A negative pressure device (not show in figures) could be disposed under the second conveyor 50 to give a slight negative pressure downward, to help the down-like pre-prepared layer 12 maintain a fixed shape.

In some embodiments, the first core-sheath fiber 20 of the base layer 10 could bind the adjacent first and second core-sheath fibers 20, the adjacent first and second microfibers 21 and the adjacent first and second 3D curly fibers 22 to form multiple binding points via the sheath part 201 of the first core-sheath fiber 20. And, the second core-sheath fiber 20 of the down-like layer 11 could bind the adjacent first and second core-sheath fibers 20, the adjacent first and second microfibers 21 and the adjacent first and second 3D curly fibers 22 to form multiple binding points via the sheath part 201 of the second core-sheath fiber 20.

The down-like composite structure of the present invention 1 could maintain a fixed shape without any additional fixing layer (such as a fixing layer formed by spraying a resin on the down-like layer in order to fix fiber interlocking points on the surface, thereby preventing fiber-migration).

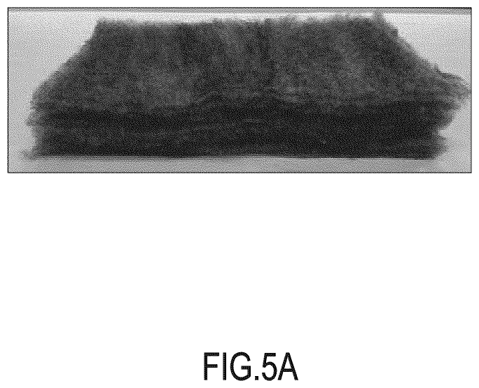

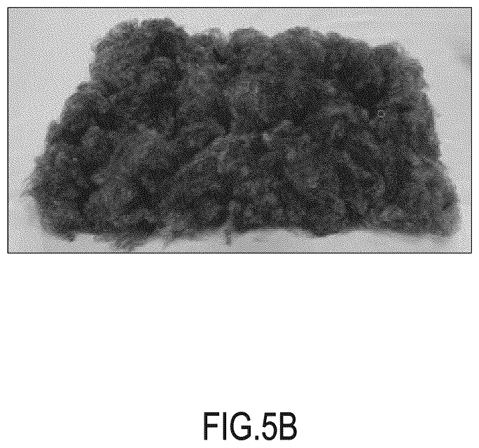

FIG. 5A is a photograph representing a commercially available padded fabric having a structure stacked by multiple layers of non-woven fabrics composed of thermal insulating fibers, and the photograph of the down-like composite structure of the present invention is presented in FIG. 5B. The structural difference can be observed by naked eyes. The down-like composite structure of the present invention has a down-like layer evenly distributed with irregularly stacked puffy fiber masses, which looks like clouds.

### Characteristics of the Down-Like Composite Structure of the Present Invention

The down-like composite structures of Examples 1 to 6 were prepared by the following materials:

1. The Base layer
(1) 30 wt % to 60 wt % of the first core-sheath fiber:
   the material of the core part/sheath part is regenerated PET/regenerated coPET, and the core part and sheath part are each in an amount of 50 wt %; the sheath part covers all of the outer surface of the core part; the fiber cross section is circular, the core part of the cross section is located centrally in the circular cross section of the first core-sheath fiber;
   the fineness is 2 D to 4 D.
(2) 10 wt % to 50 wt % of the first microfiber:
   the material is regenerated PET;
   the fineness is 0.9 D to 1.4 D;
   solid fiber, or hollow fiber having a hollowness of 5% to 20%.
(3) 20 wt % to 30 wt % of the first 3D curly fiber:
   the material of first side part/second side part is regenerated PET/regenerated PET, wherein the inherent viscosity difference (ΔIV) between the first polyethylene terephthalate of the first side part and the second polyethylene terephthalate of the second side part is 0.15 dL/g or more; solid fiber having a circular cross section, and the first side part and the second side part of the cross section are semicircular in shape and oppositely disposed;
   the fineness is 1 D to 15 D;
   the hollowness is 5% to 30%;
   the crimp rate is 2% to 25%.

### 2. The Down-Like Layer

(1) 10 wt % to 30 wt % of the second core-sheath fiber:
   the material of the core part/sheath part is regenerated PET/regenerated coPET, and the core part and sheath part are each in an amount of 50 wt %; the sheath part covers all of the outer surface of the core part; the fiber cross section is circular, the core part of the cross section is located centrally in the circular cross section of the second core-sheath fiber;
   the fineness is 2 D to 4 D.
(2) 30 wt % to 70 wt % of the second microfiber:
   the material is regenerated PET;
   fineness is 0.1 D to 1.5 D;
   solid fiber, or hollow fiber having a hollowness of 5% to 20%.
(3) 20 wt % to 40 wt % of the second 3D curly fiber:
   the material of first side part/second side part is regenerated PET/regenerated PET, wherein the inherent viscosity difference (ΔIV) between the first polyethylene terephthalate of the first side part and the second polyethylene terephthalate of the second side part is 0.15 dL/g or more; solid fiber having a circular cross section, and the first side part and the second side part of the cross section are semicircular in shape and oppositely disposed;
   the fineness is 1 D to 15 D;
   the hollowness is 5% to 30%;
   the crimp rate is 2% to 25%.

CLO value of the down-like composite structure of Examples 1 to 6 (E1 to E6) of the present invention was measured. The results are shown in Table 1 below:

TABLE 1

| | | E1 | E2 | E3 | E4 | E5 | E6 |
|---|---|---|---|---|---|---|---|
| Base | Density | 16 | 16 | 22 | 22 | 30 | 30 |
| layer | (gsm) | | | | | | |
| | Thickness | 0.1 | 0.1 | 0.2 | 0.2 | 0.3 | 0.3 |
| | (cm) | | | | | | |
| Down- | Density | 34 | 64 | 78 | 118 | 150 | 190 |
| like | (gsm) | | | | | | |
| layer | Thickness | 1.10 | 1.84 | 1.15 | 1.66 | 2.28 | 2.49 |
| | (cm) | | | | | | |
| Down- | Density | 60 | 80 | 100 | 140 | 180 | 220 |
| like | (gsm) | | | | | | |
| com- | Thickness | 1.2 | 1.94 | 1.35 | 1.86 | 2.58 | 2.79 |
| posite | (cm) | | | | | | |
| struc- | CLO | 1.27 | 1.66 | 2.12 | 2.74 | 3.21 | 3.67 |
| ture | value | | | | | | |
| | (CLO) | | | | | | |

From Table 1, it was found that when the base layer and the down-like layer used the same material, a higher density gave a higher CLO value. In addition, a thermal insulation material (sheet material) was used as Comparative Example 1 (comprising 10% to 20% of a core-sheath fiber with a fineness of 2 D to 4 D and a sheath part composed of a low-melting point material, 20% to 40% of a microfiber having a fineness of 0.9 D to 1.2 D, and 50% to 60% of a 3D curly hollow fiber having a fineness of 3 D to 7 D; and having a total weight per unit area of 200 gsm); and a commercially available traditional down-like material (padded fabric) was used as Comparative Example 2 (with fibers in the grids comprising 0% to 100% of a microfiber having a fineness of 0.9 D to 1.2 D, and 100% to 0% of 3D curly hollow fiber having a fineness of 3 D to 7 D; and having a weight per unit area of 200 gsm), and Example 5 (with a total weight per unit area of 180 gsm) which had similar weight per unit area was selected for measurement and comparison with Comparative Examples 1 and 2.

Example 5 (E5) and Comparative Examples 1 and 2 (CE1 and CE2) are measured according to the standard methods below. The results are listed in Table 2 below.

1. Weight per unit area: measured according to the standard method ASTM D3776, with the unit of grams per square meter (abbreviated as gsm, or g/m²).

2. Thickness: measured according to the standard method ASTM D5736-95.

3. Clothing insulation value (CLO value): measured according to the standard method ASTM D1518 to obtain CLO value with a unit of CLO.

4. Launderability: measured according to the standard method ASTM D4770. The measurement results have five levels, wherein Level 5 represents the best launderability. Two types of samples were used in the launderability tests: 40 cm×40 cm (with a grid size of 10 cm×10 cm) and 30 cm×30 cm.

(1) Test regarding thermal insulating materials as a sheet material or a roll material: a sample having a size of 30 cm×30 cm, the sample size used for thermal insulating materials as a sheet material or a roll material. Comparative Example 2 was a traditional down-like material (padded fabric), not a sheet material, so a sample sizing of 30 cm×30 cm was directly cut (without sewing any grid thereon) for measurement. Generally, a resin is used to fix the fiber interlocking points on the surface of sheet-type thermal insulating materials, so the sheet-type thermal insulating materials have a better launderability.

(2) Test regarding padded fabric materials: a sample having a size of 40 cm×40 cm (with a grid size of 10 cm×10 cm), the sample size used for traditional down-like materials. Comparative Example 1 was a sheet material, not a padded fabric, so a sample sizing of 40 cm×40 cm was directly cut (without sewing any grid thereon) for measurement. Generally, the traditional padded down-like material fills down in grids, no low-melting point fiber is added, and no resin is used to fix the fiber interlocking points on the surface, so down fibers tangle easily in the grids during washing; and, the bigger size of the grids gives a lower level of the launderability.

5. Fiber-migration after washing: measured according to the standard method ASTM D4770. The measurement results have five levels, wherein Level 5 represents the least fiber-migration after washing.

6. Compression recovery rate: measured according to the standard method ASTM D6571-01.

TABLE 2

| | | E5 | CE1 | CE2 |
|---|---|---|---|---|
| | | Down-like | Thermal | Traditional |
| | | composite | insulation | down-like |
| | | structure | material | material |
| Fiber arrangement | | Base layer: | Horizontally | Randomly |
| | | horizontally | and orderly | |
| | | and orderly | | |
| | | Down-like | | |
| | | layer: randomly | | |
| Total weight per | | 180 | 200 | 200 |
| unit area (gsm) | | | | |
| Thickness (cm) | | 3.2 | 3.2 | 3.0 |
| CLO value (CLO) | | 3.4 | 3.4 | 3.2 |
| CLO value/ thickness | | 1.06 | 1.06 | 1.07 |
| (CLO/cm) | | | | |
| Launderability | Wash 5 | Level 4 | Level 4 | Level 1 |
| (30 × 30) | times | | | |
| | Wash 10 | Level 4 | Level 4 | Level 1 |
| | times | | | |
| Launderability | Wash 5 | Level 4 | Level 4 | Level 4 |
| (40 × 40) | times | | | |
| | Wash 10 | Level 4 | Level 4 | Level 4 |
| | times | | | |
| Fiber- | Wash 3 | Level 5 | Level 5 | Level 5 |
| migration | time | | | |
| Compression recovery | | 92.7% | 72.0% | 83.6% |
| rate (%) | | | | |
| Processability | Grid | Not needed | Not needed | Needed |
| for preparing | Fiber- | | | |
| clothing | filling | No | No | Needed |
| | process | | | |

The down-like composite structure of the present invention comprises a combination of a base layer with fibers horizontally and orderly arranged; and a down-like layer with fibers randomly arranged, so the down-like composite structure of the present invention has better expansion and compression recovery rate. Comparative Example 1 with fibers horizontally and orderly arranged fiber has a good launderability; Comparative Example 2 with fibers randomly arranged has a good expansion; however, the two comparative examples cannot have both good expansion and launderability, and also have a lower compression recovery rate. In order to have a good launderability, the grid size must be considered in traditional down-like material of Comparative Example 2; however, the down-like composite structure of the present invention and Comparative Example 1 can have a good launderability without considering any grid issue.

From above, it is clear that the present invention provides a down-like composite structure, which is a sheet material that can be prepared as a roll material, and it can be directly applied to the designs of thermal insulating clothes and articles (such as shoes, a comforter, a sleeping bag, a sleeping pad, a clothing accessor, and so on), no fiber filling process is needed, and the down-like composite structure of the present invention has a soft feel of the down-like material, good CLO value, good launderability, and low fiber-migration. In addition, resin for fixing fiber interlocking points on the surface in order to prevent fiber-migration is not needed for the down-like composite structure of the present invention, and the down-like composite structure of the present invention has good compression recovery rate.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A down-like composite structure, comprising:
a base layer, based on the total weight of the down-like composite structure, the base layer having a weight of 9 wt % to 27 wt %; the base layer comprising 30 wt % to 60 wt % of a first core-sheath fiber, 10 wt % to 50 wt % of a first microfiber and 20 wt % to 30 wt % of a first 3D curly fiber; the first core-sheath fiber, the first microfiber and the first 3D curly fiber mixed and cross-stacked to obtain the base layer, and the base layer having a density of 14 gsm to 40 gsm; and
a down-like layer disposed on the base layer, based on the total weight of the down-like composite structure, the down-like layer having a weight of 73 wt % to 91 wt %; the down-like layer comprising 10 wt % to 30 wt % of a second core-sheath fiber, 30 wt % to 70 wt % of a second microfiber and 20 wt % to 40 wt % of a second 3D curly fiber; the second core-sheath fiber, the second microfiber and the second 3D curly fiber mixed and randomly stacked to obtain the down-like layer, and the down-like layer having a density of 30 gsm to 400 gsm;
wherein, the first core-sheath fiber and the second core-sheath fiber individually comprise a core part and a sheath part, and the sheath part covers part of or all of the outer surface of the core part; the core part is made of a virgin or recycled first polymer material, the sheath part is made of a virgin or recycled second polymer material, the melting point of the second polymer material is lower than the melting point of the first polymer material, and the melting point of the second polymer material ranges from 100° C. to 200° C.;
the first microfiber and the second microfiber individually have a fineness of 0.1 D to 1.5 D;
the first 3D curly fiber and the second 3D curly fiber individually have a hollowness of 5% to 30%; and
the first 3D curly fiber and the second 3D curly fiber individually have a crimp rate of 2% to 25%.

2. The down-like composite structure as claimed in claim 1, wherein, based on the total weight of the first core-sheath fiber, the core part is in an amount of 40 wt % to 80 wt %, and the sheath part is in an amount of 60 wt % to 20 wt %; and, based on the total weight of the second core-sheath fiber, the core part is in an amount of 40 wt % to 80 wt %, and the sheath part is in an amount of 60 wt % to 20 wt %.

3. The down-like composite structure as claimed in claim 1, wherein the first core-sheath fiber and the second core-sheath fiber individually have a cross section, the cross section is circular or trilobal shaped; when the cross section is circular, the core part is located centrally or non-centrally in the circular cross section, and the sheath part covers all of the outer surface of the core part; when the cross section is trilobal shaped, the sheath part covers part of the outer surface of the core part.

4. The down-like composite structure as claimed in claim 1, wherein the first polymer material and the second polymer material are individually selected from a group consisting of polyethylene, polypropylene, polyethylene terephthalate, polyethylene terephthalate copolymer and other polymer analogues.

5. The down-like composite structure as claimed in claim 4, wherein the combination of the first polymer material and the second polymer material is expressed in first polymer material/second polymer material, and the first polymer material/the second polymer material is selected from a group consisting of polyethylene terephthalate/polyethylene, polyethylene terephthalate/polyethylene terephthalate copolymer, and polypropylene/polyethylene.

6. The down-like composite structure as claimed in claim 1, wherein the first microfiber and the second microfiber are individually made of a virgin or recycled third polymer material selected from a group consisting of polyethylene, polypropylene, polyethylene terephthalate, polytrimethylene terephthalate, polybutylene terephthalate, polyamide and a combination thereof.

7. The down-like composite structure as claimed in claim 1, wherein the first 3D curly fiber and the second 3D curly fiber are individually a side-by-side bicomponent fiber, and the side-by-side bicomponent fiber comprises a first side part and a second side part disposed parallelly to each other, the first side part is made of a virgin or recycled fourth polymer material, the second side part is made of a virgin or recycled fifth polymer material, and the fourth polymer material and the fifth polymer material are individually selected from a group consisting of polyethylene, polypropylene, polyethylene terephthalate, polyethylene terephthalate copolymer, polybutylene terephthalate, polyamide and other polymer analogues.

8. The down-like composite structure as claimed in claim 1, which has a compression recovery rate of 90% or more.

9. An article or clothes prepared by the down-like composite structure as claimed in claim 1.

10. The article or clothes as claimed in claim 9, wherein the article is shoes, a comforter, a sleeping bag, a sleeping pad or a clothing accessory; and the clothes are a shirt, a blouse, trousers, a skirt, a vest, or a coat.

11. An article or clothes prepared by the down-like composite structure as claimed in claim 2.

12. An article or clothes prepared by the down-like composite structure as claimed in claim 3.

13. An article or clothes prepared by the down-like composite structure as claimed in claim 4.

14. An article or clothes prepared by the down-like composite structure as claimed in claim 5.

15. An article or clothes prepared by the down-like composite structure as claimed in claim 6.

16. An article or clothes prepared by the down-like composite structure as claimed in claim 7.

17. An article or clothes prepared by the down-like composite structure as claimed in claim 8.
